(19) United States
(12) Patent Application Publication
(10) Pub. No.: US 2016/0221705 A1
(43) Pub. Date: Aug. 4, 2016

(54) GLUING DEVICE COMPRISING A GLUE SCRAPER AND LABELING UNIT

(71) Applicant: KHS GMBH, Dortmund (DE)

(72) Inventor: Hanno Gollek, Dortmund (DE)

(21) Appl. No.: 15/029,338

(22) PCT Filed: Oct. 21, 2014
(86) PCT No.: PCT/EP2014/072517

§ 371 Date: Apr. 14, 2016

(30) Foreign Application Priority Data
Oct. 22, 2013 (DE) 10 2013 111 625.6

(51) Int. Cl. B65C 9/20

(52) U.S. Cl. CPC B65C 9/20; B65C 2009/0078

(57) ABSTRACT

A gluing device includes a glue scraper having doctor blades, each with a corresponding blade-edge configured to scrape off surplus glue from a circumferential surface of a glue roll and to produce a layer of glue with a controlled glue thickness on a label. The doctor blades are adjustable relative to one another along a direction of the blade edges. This adjustment sets a width of the layer of glue. The doctor blades lie in contact with each other and are configured in the manner of a leaf Either one or both of is adjustable for setting the width.

### RELATED APPLICATIONS

This application is the national stage, under 35 USC 371, of PCT/EP2014/072517, filed on Oct. 21, 2014, which claims the benefit of the Oct. 22, 2013 priority date of DE 102013111625.6, the contents of which are herein incorporated by reference.

### FILED OF INVENTION

The invention is directed to labeling containers, and in particular, to a gluing device having a glue scraper.

### BACKGROUND

A common way to affix a label to a container is by gluing it to the container. This requires applying the glue.

Known ways of applying glue, either directly onto the labels or indirectly via label pallets, usually use glue rolls having circumferential surfaces. The glue roll has a circumferential surface that is to be coated in glue. As it rotates, thus surface moves past a glue applicator. The glue applicator coats the surface with glue.

The surface then moves past a glue scraper. The glue scraper controls the glue's thickness and returns surplus glue to a glue container. In many cases, another glue scraper just upstream of the glue applicator removes any unused label glue from the circumferential surface before the glue applicator applies fresh label glue.

Container labels come in many sizes and shapes. As a result, a typical glue applicator should work with labels of different sizes. It is therefore useful to be able to adjust the width of the glue application to suit the labels. A disadvantage of known glue applicators is that the adjustment is not that easy. This is because adjustment involves modifying many different glue scrapers or doctor blades.

### SUMMARY

In one aspect, the invention features a glue scraper having at least two doctor blades that are arranged with their blade edges following one another in the rotating or running direction of the glue roll. These blade edges preferably lie against each other. One of the blade edges comes first relative to the rotating or running direction of the glue roll. In some embodiments, that blade edge is at a distance from the circumferential surface of the glue roll. This distance matches the defined glue thickness on the glue roll. On the other hand the other blade edge, and preferably that which comes second relative to the rotating or running direction of the glue roll, lies up against the circumferential surface of the glue roll or is at least arranged at such a short distance from the circumferential surface of the glue roll or is advanced so far towards the circumferential surface of the glue roll that within its range of action, label glue is completely or essentially completely removed from the glue roll. The doctor blades can be adjusted in the direction of their blade edges, including relative to one another such that depending on this adjustment, the glue application applied by the glue applicator to the glue roll can be more or less removed again by the second blade edge. In this way the width of the controlled glue application that is present on the glue roll after it passes the glue scraper is adapted by the second blade edge to the size or width of the label that is to be processed.

An alternative embodiment includes a leaf-like or film-like spacer element inserted at least over a partial area between the doctor blades lying against one another. The spacer has a thickness that depends on the specific gluing task or container form. In most cases, this thickness ranges from 0.05 to 3 mm. The spacer comprises a suitable heat-resistant material. Embodiments include those in which it is a metallic material, a heat-resistant plastic, particularly polytetrafluoroethylene, or a suitable cellulose-containing material.

The spacer does more than just improve the adjustment of the desired glue thickness and ease the effort required to adapt the relative position of the doctor blades to one another and to the container. The spacer also improves the detaching of the doctor blades from one another. This makes it easier to the doctor blades.

In one aspect, the invention features a gluing device for a labeling unit. Such a gluing device includes a glue scraper having first and second doctor blades, each with a corresponding first and second blade-edge configured to scrape off surplus glue from a circumferential surface of a glue roll and to produce a layer of glue with a controlled glue thickness on a label. The first and second doctor blades are adjustable relative to one another along a direction of the first and second blade edges. This adjustment sets a width of the layer of glue. The first and second doctor blades lie in contact with each other and are configured in the manner of a leaf. Either one or both of the two doctor blades is adjustable for setting the width.

Some embodiments also feature a spacer arranged between the first and second doctor blades. Such a spacer can be a film or a leaf. Also among the embodiments are those with a leaf arranged between the first and second doctor blades and those with a film arranged between the two doctor blades.

In some embodiments, the blade edges succeed one another in an axial direction at right angles to the blade edges.

Also among the embodiments are those having a common blade carrier that holds the doctor blades.

Some embodiments include an attachment strip. In these embodiments, at least one of the two doctor blades is adjustably attached to the attachment strip to permit setting of the width.

In other embodiments, a suspension holds the first and second doctor blades.

Also among the embodiments are those that include a blade carrier and a glue-scraper carrier. In these embodiments, the blade carrier is attached to the glue scraper carrier, and the glue scraper carrier is mounted to be able to swivel.

Some embodiments also feature a spring-loaded mount that holds the first and second doctor blades. Typically, this spring-loaded mount is disposed on a blade carrier that holds the first and second doctor blades.

Yet other embodiments include a labeling unit of a labeling machine for labeling and decorating containers with labels that are applied using label glue. In these embodiments, the gluing device comprises a glue roll that can be driven to rotate about a roll axis, and a glue applicator for applying the label glue to a circumferential surface of the glue roll. The glue scraper is disposed to control glue thickness on the circumferential surface.

In some embodiments, during normal operation of the gluing device, the first blade edge is spaced from the circumferential surface by a distance, wherein the distance equals the glue thickness, wherein the second doctor blade is configured to enable the second blade edge to be laid against the circumferential surface such that, within a range of action of the second doctor blade, glue is completely removed from the circumferential surface. In some of these embodiments, during normal operation of the gluing device, the first blade edge is spaced from the circumferential surface by a distance that equals the glue thickness. In others, it configured to enable the second blade edge to be relatively far toward the circumferential surface. In both these cases, within its range of action, the second doctor blade, completely removes glue from the circumferential surface.

As used herein, “label glue” includes cold and hot label glues, included a solvent-based glue or a water-based glue.

As used herein, a “controlled glue thickness” of the glue application is the glue thickness produced by the distance of a blade edge from the circumferential surface of the glue roll or by the working gap between the blade edge and the circumferential surface of the glue roll.

As used herein, “width of the glue layer” means the width of the glue layer on the circumferential surface of the glue roll in the direction of the glue roll axis.

As used herein, expressions such as “essentially,” “in essence” or “around” mean variations from a respective exact value by ±10%, preferably by ±5% and/or variations in the form of changes insignificant for the function.

Further embodiments, advantages, and possible applications of the invention arise out of the following description of embodiments and out of the figures. All of the described and/or pictorially represented attributes whether alone or in any desired combination are fundamentally the subject matter of the invention independently of their synopsis in the claims or a retroactive application thereof. The content of the claims is also made an integral part of the description.

### BRIEF DESCRIPTION OF THE DRAWINGS

These and other features of the invention will be apparent from the following figures in which:

FIG. 1 shows a plan view of a glue roll and a glue scraper of a gluing device of a labeling unit of a labeling machine;

FIG. 2 is a perspective view of the glue roll and glue scraper of FIG. 1;

FIGS. 3a, 3b and 4a are enlarged representations of the glue scraper of FIG. 1 from above and below;

FIG. 5 is a perspective view of the glue scraper of FIG. 1;

FIGS. 6 and 7 show the glue scraper of FIG. 1 in different side views, with FIG. 7 showing a partly sectional view; and

FIG. 8 shows an enlarged partial view of the sectional view shown in FIG. 7.

### DETAILED DESCRIPTION

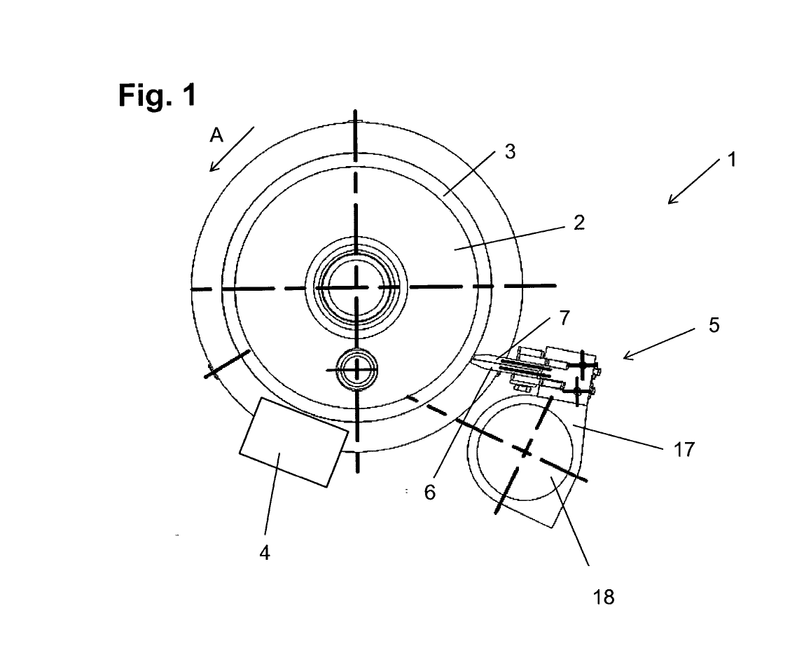

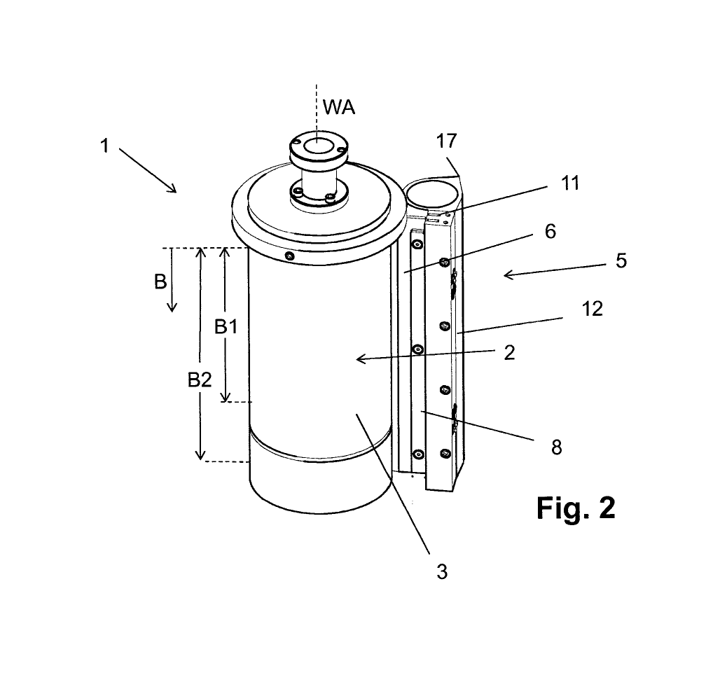

FIGS. 1 and 2 show a gluing device 1 that is part of a labeling unit of a labeling machine used for gluing labels to containers. The gluing device 1 comprises a glue roll 2 having a circumferential surface 3. The glue roll 2 rotates along a rotation direction A about its roll axis WA. In the illustrated embodiment, the roll axis WA is a horizontal or essentially horizontal axis. The gluing device applies a glue layer having a controlled thickness and width.

As the glue roll 2 rotates, its circumferential surface 3 moves past a glue applicator 4 and past a glue scraper 5. The glue scraper 5 controls the thickness of the glue that is present on the circumferential surface 3. This control over the glue's thickness extends along a width of the circumferential surface 3 that is oriented parallel to the roll axis WA. This width matches the width of the labels. After the circumferential surface 3 has moved past the glue scraper 5, the glue that was applied it is transferred from the glue roll 2 to labels or to label pallets of the labeling unit as they move past the glue roll 2.

The glue scraper 5 includes a first doctor blade 6 having a first blade edge 6.1 and a second doctor blade 7 having a second blade edge 7.1. The first and second doctor blades 6, 7 lie on each other, with the second doctor blade 7 being shorter than the first doctor blade 6. The first and second doctor blades 6, 7 are disposed such that, in the direction of rotation A of the glue roll 2, the second blade edge 7.1 follows the first blade edge 6.1.

The first blade edge 6.1 runs parallel or essentially parallel to the roll axis WA. When the labeling unit is in operation, a gap separates the first blade edge 6.1 from the circumferential surface 3. This gap equals the thickness of the glue layer.

The second blade edge 7.1 runs parallel or essentially parallel to the roll axis WA. It either contacts the circumferential surface 3 or is at a short distance away from the circumferential surface 3. As a result, within the range of action of the second blade edge 7.1, the applied glue is removed from the glue roll 2 and returned. This causes the second doctor blade 7 to reduce an effective width B of the roll axis WA after the passage of the glue scraper 5.

Adjusting the second doctor blade 7 relative to the first doctor blade 6 sets the width B of the applied glue so that it matches the label. To carry out this adjustment, adjusting the positions of the first and second doctor blades 6, 7 relative to each other in the axial direction. In the illustrated embodiment, this is the direction of the roll axis WA. In particular, the second doctor blade 7 is adjusted between a first state and a second state.

In the first state, the first doctor blade 6 completely covers the second doctor blade 7. As a result, the second doctor blade 7 removes a width of glue that is equal to the full length of the second blade edge 7.1, starting from one edge, for example from the lower edge of the original glue layer. The second blade edge 7.1 is thus completely or essentially completely within the range of action of the first blade edge 6.1.

In the second state, the first doctor blade 6 fails to completely cover the second doctor blade 7. In fact, in some embodiments, the first doctor blade 6 does not cover the second doctor blade 7 at all. This means that the second blade edge 7.1 lies outside the range of action or working range of the first blade edge 6.1 so that the second doctor blade 7 removes no glue.

There is therefore a smaller width B1 for the glue layer in the first state and a greater width B2 in the second state. Any desired width B can be set between the widths associated with the first and second state.

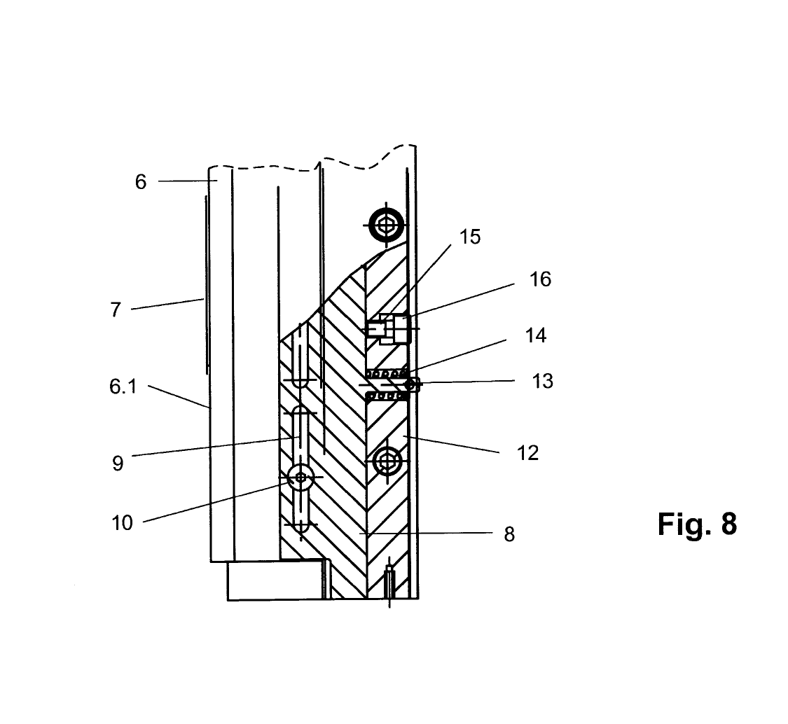

Each of the first and second doctor blades 6, 7 is held on a dedicated attachment strip 8, with at least the second doctor blade 7, but preferably both the first and second doctor blades 6, 7, being held by retaining screws 10 that engage through adjustment slots 9 in the attachment strip 8, as shown in FIG. 8. The adjustment slots 9 extend longitudinally along a direction parallel to the first and second blade edges 6.1, 7.1 and parallel to the roll axis WA.

The resulting row of adjustment slots 9 permits a rough or step-by-step setting of the relative blade positions. In particular, selecting the slots 9 used for attaching the first and second doctor blades 6, 7 allows one to coarsely adjust of blade position.

The fact that the each adjustment slot 9 extends longitudinally also make it possible to carry out a fine or continuous setting of the first and second doctor blades 6, 7 in the longitudinal direction by moving them within the particular adjustment slots 9 selected for attachment.

The attachment strips 8 are held in attachment slots 11 of a strip-like blade carrier 12. Each attachment strip 8 comprises rear pins 13 that engage holes in the blade carrier 12. As shown in FIG. 8, a compression spring 14 surrounds each rear pin 13, thus spring-loading the attachment strips 8.

Each compression spring 14 is supported off the blade carrier 12 and the attachment strip 8 so as to urge the attachment strip 8, together with the first and second doctor blades 6, 7, toward the glue roll 2.

The attachment strips 8 also include rear threaded pins 15 that engage further holes in the blade carrier 12. Arranged on the rear threaded pins 15 are female thread fittings 16 that are supported off the blade carrier 12 so as to be accessible from the outside. These are useful for accurately adjusting the blade gap, i.e. the path and distance of the first blade edge 6.1 and the second blade edge 7.1, relative to the circumferential surface 3 against the action of the compression springs 14, even while the labeling unit is running. The spring-loaded mounting also makes it possible to advance the second doctor blade 7 so far towards the glue roll 2 that the second blade edge 7.1 contacts the circumferential surface 3.

The blade carrier 12 is provided on the outside of a ring-shaped or tubular glue scraper carrier 17 that is arranged so as to be able to swivel on a shaft 18 that is oriented with its axis parallel to the roll axis WA. Swiveling the glue scraper carrier 17 advances or retracts the glue scraper 5, together with its first and second doctor blades 6, 7 towards or away from the glue roll 2 or its circumferential surface 3.

Some embodiments include swiveling device for swiveling the glue carrier 5 configured for manual swiveling. In other embodiments, the swiveling device includes a motor for carrying out motorized swiveling. Among these are embodiments with at least one pneumatic cylinder. In these embodiments, while labeling is in progress, the distance between the first and second blade edges 6.1, 7.1 and the circumferential surface 3 is set as a function of the labels that are to be processed.

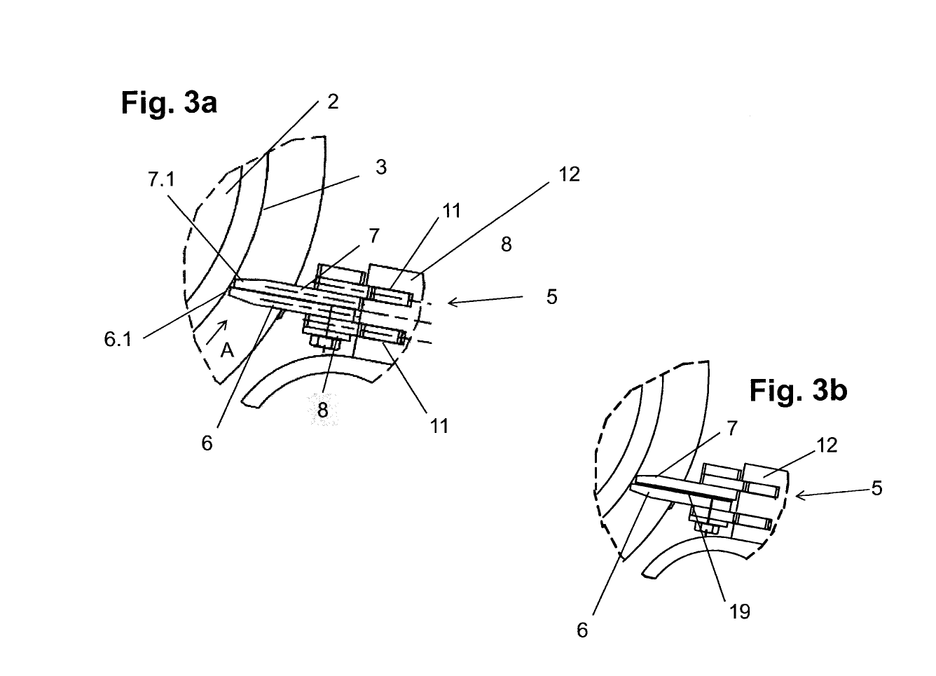

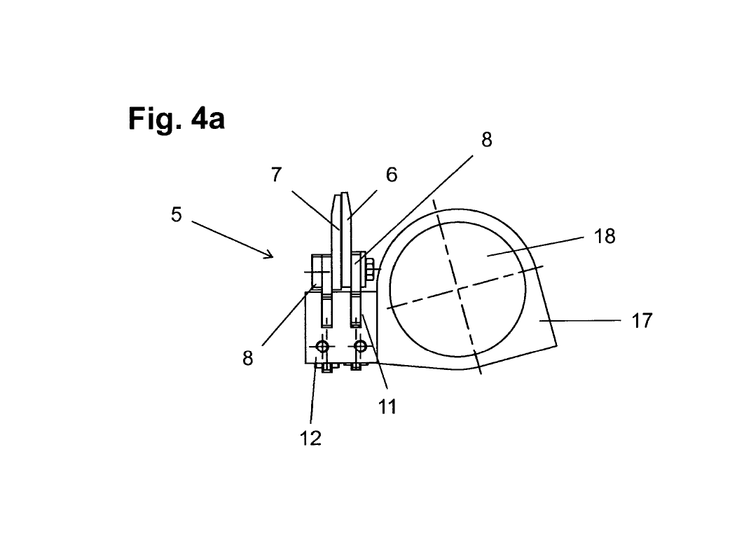

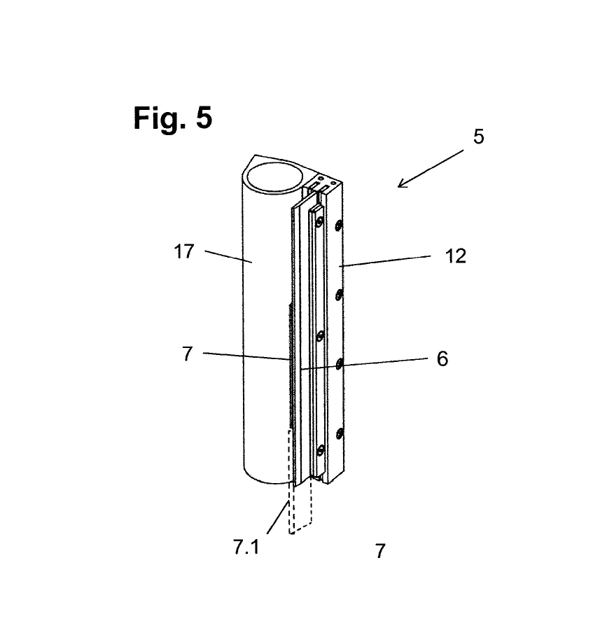

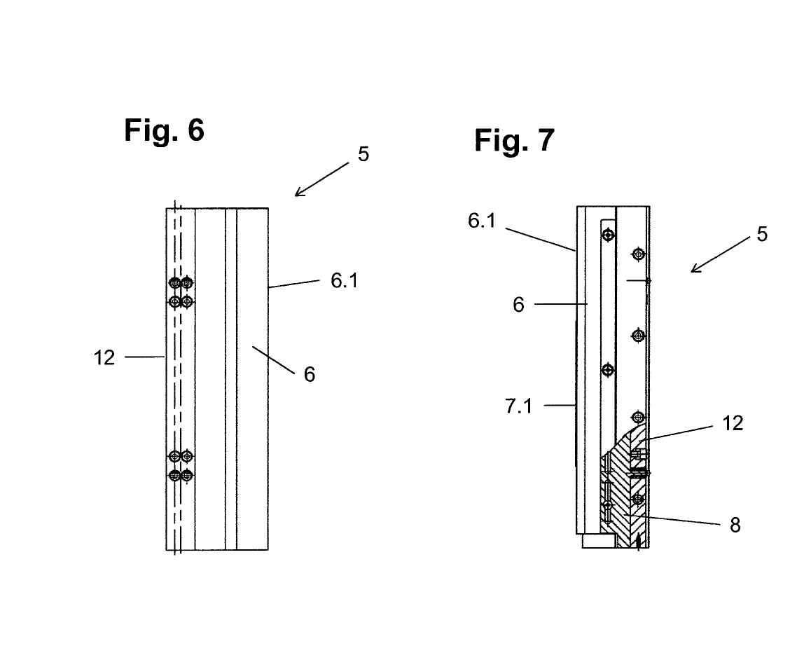

FIG. 3b shows an embodiment in which a spacer 19 separates the first and second doctor blades 6, 7 to make them easier to move relative to each other. A useful material spacer 19 is a 1.5 mm thick leaf-shaped Teflon spacer element 19.

The illustrated embodiment has first and second doctor blades 6, 7 that are of different lengths in the direction of their blade edges 6.1, 7.1. However, it is also possible for the first and second doctor blades 6, 7 to be of equal length.

In some cases it is also possible to use the first and second doctor blades 6, 7 individually without modifying the design or individual components. This makes sense, for example, when only a single back label is to be run on a cold gluing station.

A particular advantage of the double doctor blade described herein is that it can also be used for conversions to retrofit old systems that used only a single doctor blade.

The invention has been described hereinbefore by reference to one embodiment. It goes without saying that numerous variations as well as modifications are possible without departing from the inventive concept underlying the invention.

Having described the invention, and a preferred embodiment thereof, what is claimed as new, and secured by letters patent is:

1-8. (canceled)

9. An apparatus comprising a gluing device for a labeling unit, said gluing device comprising a glue scraper, wherein said glue scraper comprises a first doctor blade, a second doctor blade, a first blade-edge, and a second blade-edge, wherein said first blade edge is an edge of said first doctor blade, wherein said second blade edge is an edge of said second doctor blade, wherein said first and second blade edges are configured to scrape off surplus glue from a circumferential surface of a glue roll and to produce a layer of glue on a label, wherein said layer of glue has a controlled glue thickness, wherein said first and second doctor blades are adjustable relative to one another along a direction of said first and second blade edges, wherein adjustment of said first and second doctor blades relative to each other sets a width of said layer of glue, wherein said first and second doctor blades are configured in the manner of a leaf, wherein said first and second doctor blades lie in contact with one another, and wherein said second doctor blade is adjustable for setting said width.

10. The apparatus of claim 9, further comprising a spacer arranged between said first and second doctor blades.

11. The apparatus of claim 9, wherein said first and second blade edges succeed one another in an axial direction, and wherein said axial direction extends at right angles to said blade edges.

12. The apparatus of claim 9, further comprising a common blade carrier, wherein said common blade carrier holds said first and second doctor blades.

13. The apparatus of claim 9, further comprising an attachment strip, wherein said first doctor blade is adjustably attached to said attachment strip to permit setting of said width.

14. The apparatus of claim 9, further comprising a suspension that holds said first and second doctor blades.

15. The apparatus of claim 9, further comprising a blade carrier and a glue-scraper carrier, wherein said blade carrier is attached to said glue scraper carrier, and wherein said glue scraper carrier is mounted to be able to swivel.

16. The apparatus of claim 9, further comprising a spring-loaded mount that holds said first and second doctor blades, said spring-loaded mount being disposed on a blade carrier that holds said first and second doctor blades.

17. The apparatus of claim 9, further comprising a labeling unit of a labeling machine for labeling and decorating containers with labels that are applied using label glue, wherein said gluing device comprises a glue roll that can be driven to rotate about a roll axis, a glue applicator for applying the label glue to a circumferential surface of said glue roll, wherein said glue scraper is disposed to control glue thickness on said circumferential surface.

18. The apparatus of claim 17, wherein, during normal operation of said gluing device, said first blade edge is spaced from said circumferential surface by a distance, wherein said distance equals said glue thickness, wherein said second doctor blade is configured to enable said second blade edge to be laid against said circumferential surface such that, within a range of action of said second doctor blade, glue is completely removed from said circumferential surface.

19. The apparatus of claim 17, wherein, during normal operation of said gluing device, said first blade edge is spaced from said circumferential surface by a distance, wherein said distance equals said glue thickness, wherein said second doctor blade is configured to enable said second blade edge to be advanced far enough toward said circumferential surface such that, within a range of action of said second doctor blade, glue is completely removed from said circumferential surface.

20. The apparatus of claim 9, further comprising a leaf arranged between said first and second doctor blades.
